(19) United States
(12) Patent Application Publication
(10) Pub. No.: US 2017/0329859 A1
(43) Pub. Date: Nov. 16, 2017

(54) Categorizing and Clipping Recently Browsed Web Pages

(71) Applicant: Evernote Corporation, Redwood City, CA (US)

(72) Inventors: Chris Ploeg, San Francisco, CA (US); Karen Scruggs, San Francisco, CA (US); Hannah Peckham, San Francisco, CA (US)

(21) Appl. No.: 15/597,076

(22) Filed: May 16, 2017

Related U.S. Application Data
(60) Provisional application No. 62/336,820, filed on May 16, 2016.

(51) Int. Cl. G06F 17/30

(52) U.S. Cl. CPC G06F 17/30884; G06F 17/3089; G06F 17/30598; G06F 17/30867; G06F 17/30873

(57) ABSTRACT

This application is directed to digital content clipping implemented by a computer with a processor and memory including one or programs executable by the processor. The computer obtains digital content and an address of a web page opened in a web browser of a user, and evaluates one or more of the digital content and the address to identify the web page as a candidate web page for clipping. The candidate web page is categorized based one or more content categories. The one or more content categories includes one or more of availability and organization of related content items, page sequence in a user browsing history, frequency of access by user, time spent on page, and one or more topic descriptions. The computer then extracts at least a fragment of the digital content into a digital content collection that is associated with the user in a content management application.

### RELATED APPLICATIONS

This application claims priority to U.S. Provisional Patent Application Serial No. 62/336,820, filed May 16, 2016, titled “Categorizing and Clipping Recently Browsed Web Pages,” which is hereby incorporated by reference in its entirety.

### BACKGROUND

Significant progress has been made on development of web clipping tools related to content management. However, existing web clipping solutions are insufficient in many areas, e.g., in supporting a contemporary web surfing workflow. Modern browsers support multi-tab browsing and detailed browsing history. According to one online poll, 57% of users have six or more open browser tabs on average, while almost 30% have over 10 opened tabs. Currently existing web clipping tools provide clips only from a currently opened page, and sometimes accumulate designated copy operations in additional clips (e.g., in EverClip 2). This may cause both over-clipping (when a user stores clips which may not be used afterwards) and under-clipping (when a user is concentrated on research and forgets to clip a page that may be subsequently lost).

### SUMMARY

Many current existing web clipping tools do not support separation of web browsing and clipping workflows and thereby cause content capturing issues. It is desirable to design methods and systems for enhancing user productivity during web clipping processes capable of supporting existing web surfing workflow.

In accordance with one aspect of this application, a method for digital content clipping is implemented in a computer with a processor and memory including one or programs executable by the processor. The method includes obtaining digital content and an address of a web page opened in a web browser of a user, and evaluating one or more of the digital content and the address to identify the web page as a candidate web page for clipping. The method further includes categorizing the candidate web page based one or more content categories. The one or more content categories includes one or more of availability and organization of related content items, page sequence in a user browsing history, frequency of access by user, time spent on page, and one or more topic descriptions. The method further includes extracting at least a fragment of the digital content into a digital content collection that is associated with the user in a content management application.

In some implementations, the method for digital content clipping further includes opening a user interface on a client display corresponding to the web page. The user interface includes one or more display components of a text entry pane for entering note information, a clipping pane for displaying clipping candidates, a summary pane for listing the one or more content categories, and an action pane for displaying a plurality of currently available actions. The method further includes displaying a set of selection snippets on the clipping pane, and the set of selection snippets are associated with one or more clipping candidates including the candidate web page.

In accordance with another aspect of this application, a computer includes a processor and memory. The memory includes one or programs executable by the processor to perform the above-described method.

In accordance with another aspect of this application, a non-transitory computer readable storage medium stores one or more programs configured for execution by a computer. The one or more programs include instructions for implementing the above-described method.

Other embodiments and advantages may be apparent to those skilled in the art in light of the descriptions and drawings in this specification.

### BRIEF DESCRIPTION OF THE DRAWINGS

FIG. 1 is a system layout and architecture of an example content clipping system including a browser application and a content management application in accordance with some implementations.

FIG. 2 is another example user interface of a browser application displayed for selection of clip candidates by category and/or action in accordance with some implementations.

FIG. 3 is an example process of selecting web page fragments in a user interface of a browser application for subsequent clipping and clipping options associated with a content management application in accordance with some implementations.

FIG. 4A is another example user interface of a browser application configured to support content clipping associated with a content management application in accordance with some implementations.

FIG. 4B is an example summary pane on a user interface of a browser application configured to support content clipping associated with a content management application in accordance with some implementations.

FIG. 5 is a flow diagram for a content management method in accordance with some implementation.

FIG. 6 is a block diagram of a computer system that manages content clipping from a browser application 102 in accordance with some implementations.

FIG. 7 is a block diagram of a computer system that manages content clipping from a browser application in accordance with some implementations.

Like reference numerals refer to corresponding parts throughout the drawings.

### DESCRIPTION OF EMBODIMENTS

Hundreds of millions of home and office users are benefiting from the new generation of unified content management systems such as the Evernote cloud service and multi-platform software developed by Evernote Corporation of Redwood City, California. A particularly advantageous feature of these systems is their ability to collect, navigate, organize, display and edit many different types and formats of content, from web pages and typed notes to photographed and scanned images, screenshots, portions of documents and emails, audio and video clips, media and document attachments and other content. Therefore, user productivity increasingly depends on the efficiency of data capturing. For example, Evernote software and service feature an extensive set of data capturing tools for desktop and mobile platforms, including web, email and document clipping applications and extensions, screenshot and markup components, page camera tool for optimal capturing of document photos using smartphone and tablet cameras, utilities for scanner integration, file auto-import capabilities, drag-and-drop addition of file attachments, Penultimate handwriting application and other data capturing capabilities used by dozens of millions of users. Additionally, integrated third party applications on the Evernote platform, such as IFTTT, FileThis, EverClip 2 and many more applications and services are facilitating data capturing into Evernote. Recent integration of Evernote with Outlook.com allows users to save Outlook emails directly into Evernote notebooks. Similar data capturing capabilities are being developed for other content and note management systems, such as Microsoft OneNote, Apple Notes, Google Keep, Simplenote, Quip, etc.

A major portion of captured content is represented by web clips. Educational, scientific, industrial, market research, travel, home, shopping and other projects in various knowledge domains often start with web research, which includes searching, surfing, comprehending, selective clipping, organizing and summarizing multiple web pages. Advanced web clipping solutions, such as the Evernote Web Clipper, offer a broad range of clipping and organizational options. This includes clipping a full page, a summary snippet of a page (a bookmark), a web address only, an article or other principal content automatically extracted from the page using special web technologies, a simplified article formatted for easy reading, a user selection from the page, a screenshot of the page, etc. Additionally, preferred notebook(s) and/or tag(s) may be suggested for filing and labeling a clip. A user may also be able to add a brief instant remark. Related content items from existing content collections may be displayed during the clipping process reminding the user of past research on a similar subject.

In accordance with various implementations of this application, a computer system performs a content clipping method that includes: processing opened browser tabs and a recent browsing history; identifying and categorizing web pages suitable for clipping; retrieving relevant content items from existing content collections of a content management application; building an automatic categorized summary of the suitable web pages; and supplying a manually opened tab or a pop-up window (also called an application window) with a user interface designed for clipping one or multiple web pages, including grouping, multiple manual or category driven selection, merging clips, merging multiple clips and optionally adding them to existing content items, organizing clips by content collection and tags, interlinking and other operations.

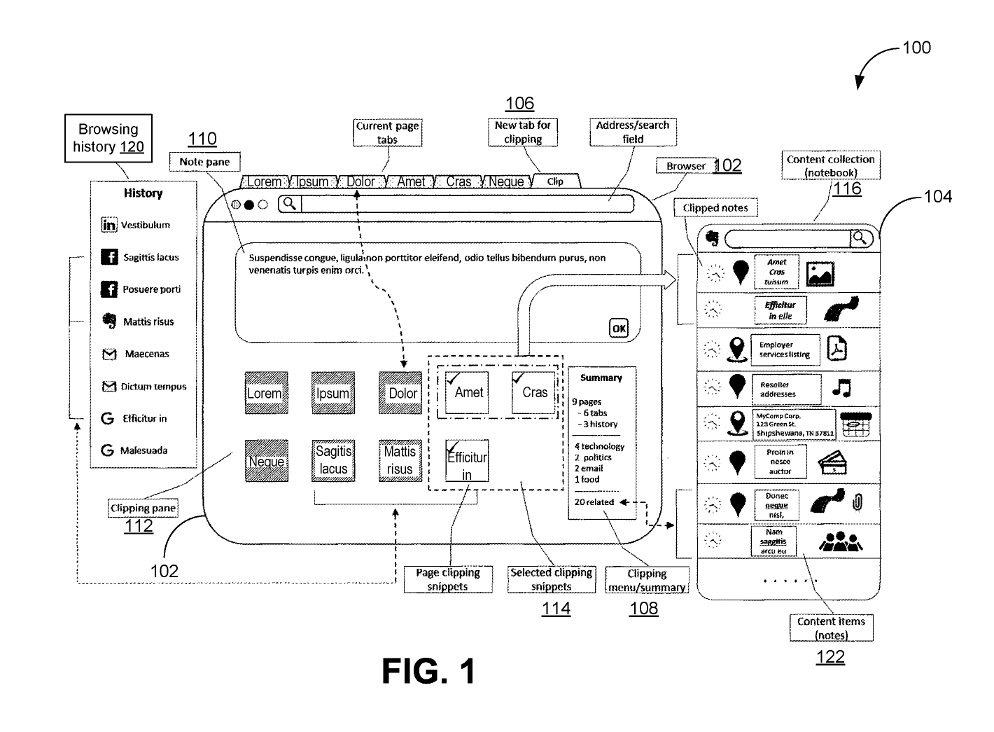

FIG. 1 is a system layout and architecture of an example content clipping system 100 including a browser application 102 (also called a web browser) and a content management application 104 in accordance with some implementations. The system 100 interacts with a web browser 102 (such as Chrome, Firefox, Safari or other browser with a sufficiently developed application program interface (API)), and provide access to browser tab content and browsing history 120 to third party applications. The system 100 also interacts with a content management system 104 (e.g., Evernote) where new clips may be filed and previously filed clips may be stored, searched, organized and processed.

A user-facing component of the system 100 may be implemented as a browser extension and/or may pop up an application window upon launching an extension. In some implementations, the system application window may be associated with a manually opened new browser tab 106. Specifically, in an example, a user interface is displayed on a client display, and includes one or more display components of a text entry pane 110 (also called a note pane) for entering note information, a clipping pane 112 for displaying clipping candidates, and a summary pane 108 for listing one or more content categories associated with the clipping candidates. In some implementations, when a user opens a new tab 106 in a system-aware browser 102, the system performs the following steps or a subset thereof:

### 1. Accessing and Processing Web Pages Corresponding to Opened Browser Tabs and to Recent Browsing History to Identify Pages Suitable for Clipping

Access depth to a browsing history 120 may be defined in system settings, may be customized by user or may change dynamically depending on various parameters, such as available space in a clipping pane 112.

Page suitability for clipping may depend on various factors and rules; certain pages may be explicitly excluded from clipping via a stop list of addresses formed by the system, by a user or by an organization (according to its IT policies). Other pages may be excluded by the system after analyzing page content, for example, if a page includes an X-rated content or is limited to a standard Thank You page without useful information, displayed by a web service or application after the user has submitted a form or performed other user actions.

### 2. Retrieving Related Pages

After candidate pages (e.g., pages corresponding to selected snippets 114) for web clipping have been identified, the system may retrieve related content items from existing content collections 116 stored in a content management system 104, employing various methods of similarity measurement, natural language processing and artificial intelligence.

### 3. Categorizing Feasible Web Pages

The system 100 may categorize candidate pages for clipping by general content type 452, user defined topics 454 and other parameters, such as availability and organization of related content items, page sequence in user browsing history 120, frequency of access by user, time spent on pages, and other parameters. The system may then form an automatic categorized summary 108 of candidate pages to facilitate subsequent clipping process. It should be noted that categorization may be automatic, manual or combined.

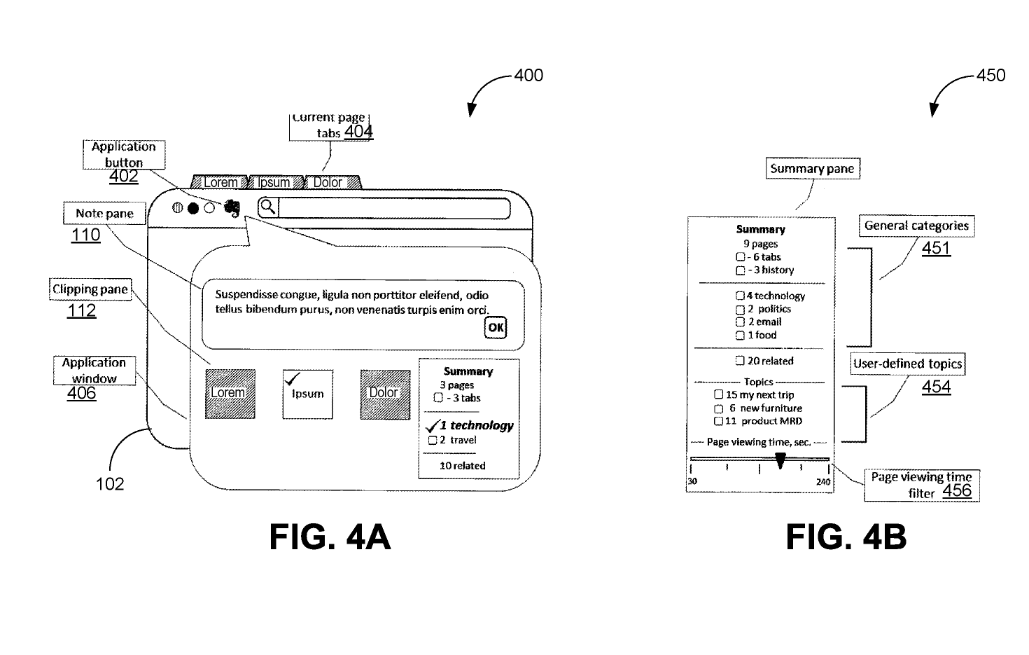

In addition to the summary pane 108 (shown in FIG. 1), FIG. 4B is another example summary pane 450 on a user interface of a browser application 102 configured to support content clipping associated with a content management application 104 in accordance with some implementations. A user defines a set of active browsing and web research topics 454, such as my next trip, new furniture, product market requirements. The system may automatically assign a topic as a category to each subsequently browsed page and request for user's confirmation/edit every time a new page is loaded. Alternatively, the user may reassign topics to pages prior to clipping or at any convenient time.

### 4. Displaying Application Page

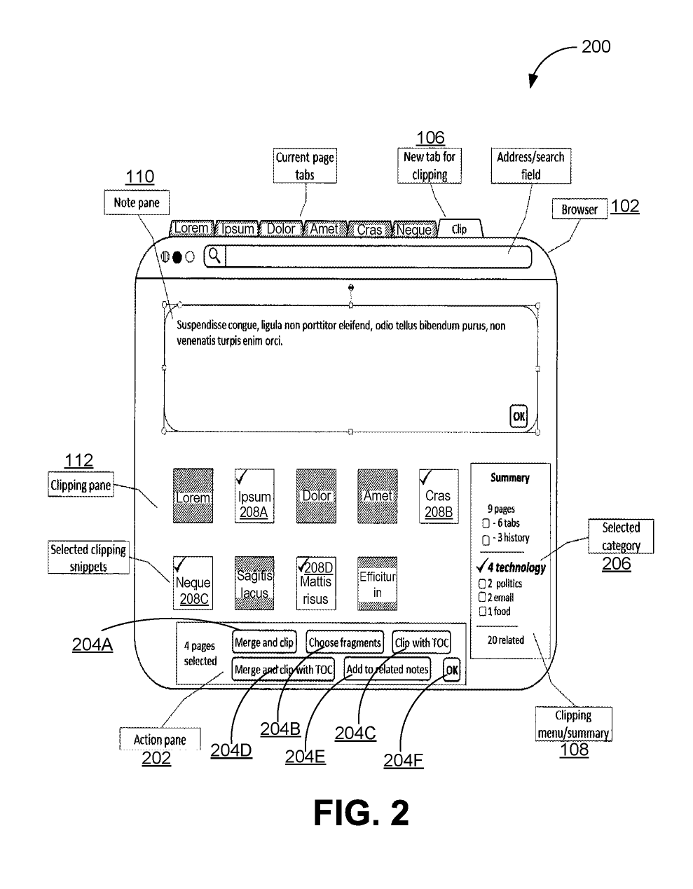

The system then may display its user interface in a dedicated pop-up window or a new web page corresponding to a newly opened tab 106. FIG. 2 is another example user interface 200 of a browser application displayed for selection of clip candidates by category and/or action in accordance with some implementations. Page layout of the user interface 106 or 200 for selection of clip candidates may include one or more components of:
a. Text entry pane 110 for entering a text note (not necessarily related to web clipping but rather for immediate text entry into a content management system).
b. Clipping pane 112 where snippets of candidate web pages are laid out and their correspondence with underlying browser tabs or history may be highlighted.
c. Summary pane 108 where a categorized page summary and other controllable parameters may be displayed.
d. Action pane 202 where action buttons (e.g., Merge and Clip action 204A, Choose Fragments action 204B, Clip with TOC 204C, Merge and Clip with TOC 204D, Add to Related Notes 204E and OK 204F) are displayed for currently available actions.

Application page may be contextually navigable; for example, on desktops or on certain types of tablets with inductive electromagnetic pen. For example, a user hovers over a clip category 206 (e.g., “technology”) in a summary pane 108, the snippets 208A, 208B, 208C and 208D corresponding to web pages that fall under the selected clip category 206 of “technology” may be highlighted.

### 5. Selecting Pages for Clipping

A user may be able to select multiple clipping candidates (e.g., candidate web pages) manually (shown in FIG. 1) and/or via a summary pane (shown in FIG. 2). In some implementations, the user selects one or several categories (including user-defined topics) or parameters (such as a filter 456 for page viewing time shown in FIG. 4B) in the summary pane 108, thereby causing an appropriate selection of candidate page snippets (e.g., snippets 114 and 208. The selection may be subsequently modified by the user.

### 6. Page Overview and Clipping Process

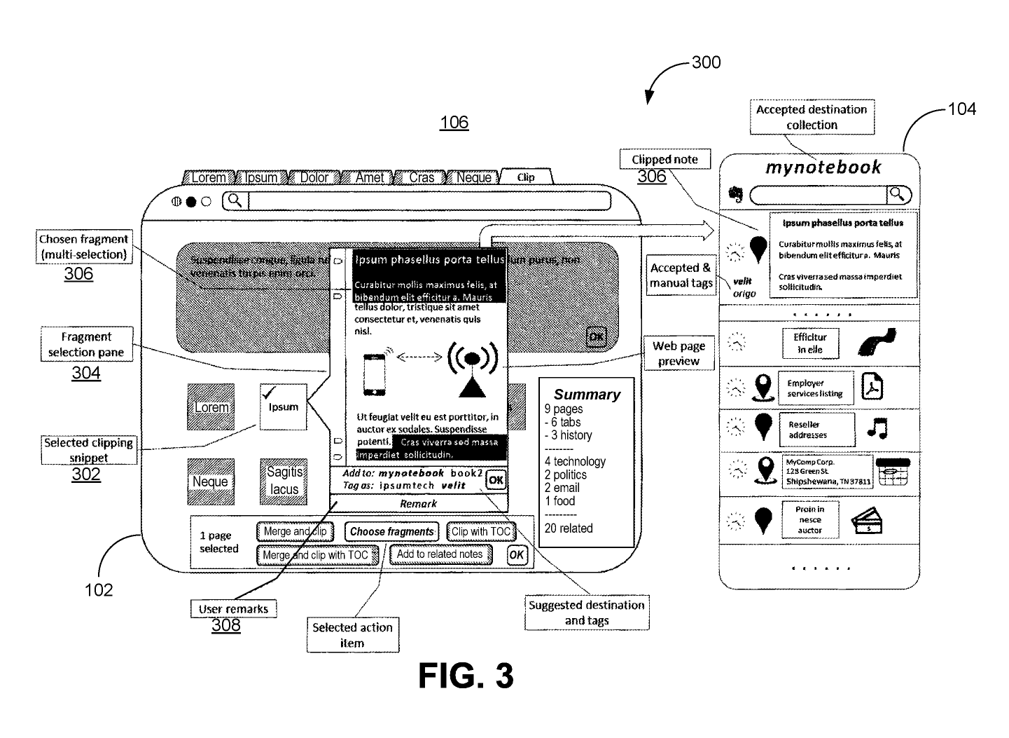

FIG. 3 is an example process 300 of selecting web page fragments in a user interface of a browser application 102 for subsequent clipping and clipping options associated with a content management application 104 in accordance with some implementations. After the selection of candidates for clipping has been completed, the user may select each clip (e.g., snippet 302) and receive a pop-up page overview 304 (also called fragment selection pane 304) with controls, allowing the user to clip the whole page, a bookmark snippet, an article or other principal content, a screenshot, etc. Alternative, the user may be able to select one or multiple fragments of the page (e.g., fragment 306) and designate the selection for clipping. Several options, without limitation, for clipping of multiple candidate pages may be available to the user:
(i) The user may create a separate content item (note) 122 in the content management application 104 for each candidate page clip.
(ii) All or some clips may be merged into a single content item 122 or generate a group of merged clips (e.g., using Merge and Clip action 204A).
(iii) Tables of content with links to each clipped content item may be created (e.g., using Clip with TOC action 204C).
(iv) Clips may be added to content collections 116 as separate content items or may be added to existing content items, either identified by the system as related items (e.g., using Add to Related Notes action 204E) or arbitrarily chosen by the user.

In addition to facilitating web clipping process for experienced users, the system 100 may be particularly helpful for new users establishing relation between their current web content and their first steps in filling the content management system 200 with a useful content.

FIG. 4A is another example user interface 400 of a browser application 102 configured to support content clipping associated with a content management application 104 in accordance with some implementations. An application button 402 is displayed on the user interface 400 of the browser application 102, which has obtained one or more content items for display on current page tabs 404. In response to a user action (e.g., a click or a hovering action) on the application button 402, the browser application 102 displays an application window 406 on top of the user interface 400 of the browser application 102. The application window 406 includes one or more of a text pane 110, a clipping pane 112, a summary pane 108 and an action pane 202. A user of the browser application 102 is prompted to select one or more content item or part of a content item for use in a content management application 104.

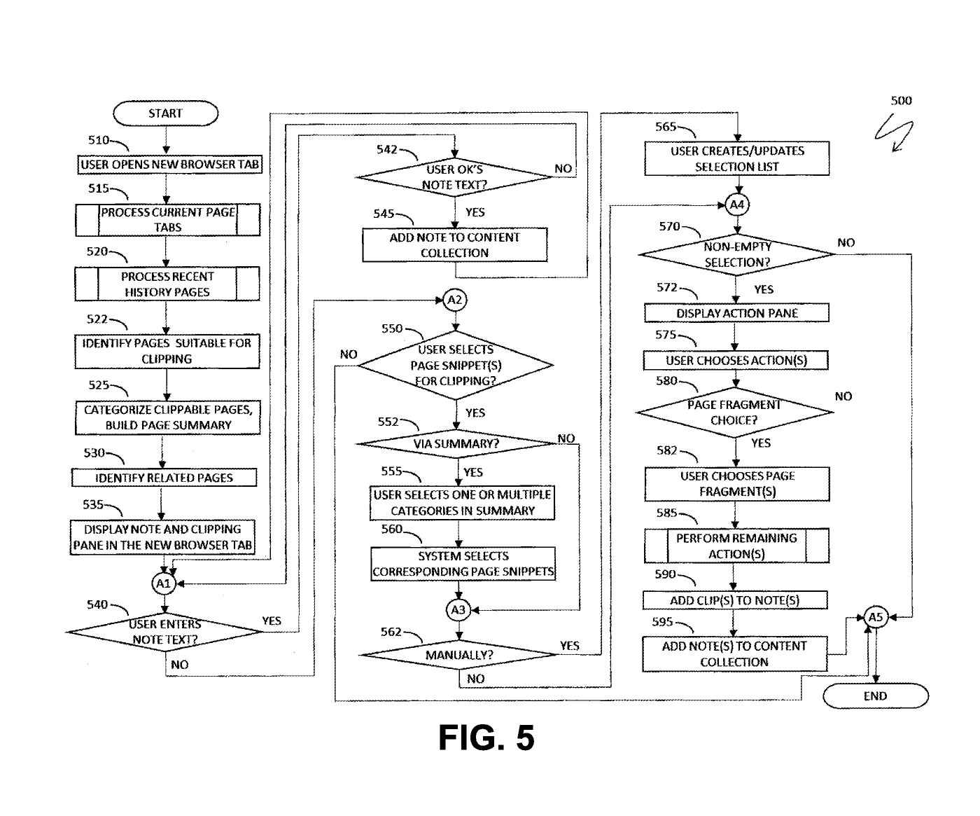

FIG. 5 is a flow diagram for an example content management method 500 in accordance with some implementation. In accordance with the content management method 500, a user of a browser application 102 opens (502) a new browser tab 106. The browser application 102 processes current page tabs (515) and recent history pages (520). The browser application 102 identifies (522) pages suitable for clipping, categorizes (525) clippable pages, builds page summary, and identifies (530) related pages. Then, the browser application 102 displays (535) a note pane 110 and a clipping pane 112 in the new browser tab 106. When a user enters (540) and approves (542) note text, the note is added (545) to the content collection 116 including one or more of the pages suitable for clipping, the page summary and the related pages.

The user selects (550) one or more page snippets (such as the snippets 114 and 208) via a summary 108 (552) or manually (562). In some implementations, when the user selects (552) the one or more page snippets for clipping via the summary 108, the user selects (555) one or more categories in the summary 108, and the browser application 102 or the content management application 104 selects (560) page snippets 114 (i.e., display items corresponding to content items) associated with the one or more categories. In some implementations, when the user selects (562) the one or more page snippets for clipping manually, the user creates or updates (565) a selection list.

When the selection is not (570) empty, the browser application 102 displays (572) an action pane 202, and prompts the user to select (575) an action 204 on the action pane 202. In some implementations, a page fragment choice is enabled (580) when a fragment selection pane 304 is displayed. Page fragments 306 are selected (582), and remaining actions are performed (585) on the fragment selection pane 304. Clips are therefore added (590 and 594) to notes in the content management application 104 according to the selection of the page snippets 114 and/or the page fragment 306.

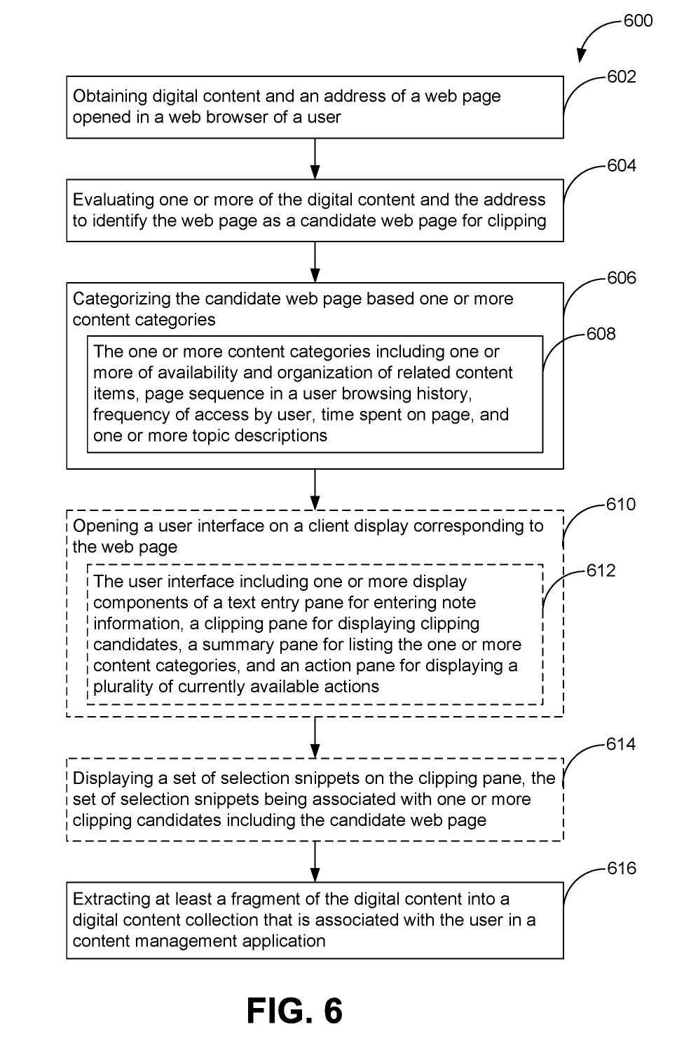

FIG. 6 is a flow chart of another example content management method 600 that manages content clipping from a browser application 102 in accordance with some implementations. The method 600 is implemented in a computer with a processor and memory including one or programs executable by the processor. The computer obtains (602) digital content and an address of a web page opened in a web browser of a user. In some implementations, the digital content and the address of the web page are retrieved from a browsing history 120 of the user in the web browser 102. After obtaining the digital content and the address of the web page, the computer evaluates (604) one or more of the digital content and the address to identify the web page as a candidate web page for clipping. For example, the computer may exclude the web page as a candidate for clipping if the address is specified on a stop list or if the digital content of the page does not include useful information or includes information that is excluded from clipping per a policy applicable to the user.

The candidate web page is then categorized (606) based one or more content categories. The one or more content categories includes (608) one or more of availability and organization of related content items, page sequence in a user browsing history 120, frequency of access by user, time spent on page, and one or more topic descriptions.

In some implementations, the web browser opens (610) a user interface (e.g., a tab for clipping 106 and an application window 406) on a client display corresponding to the web page. The user interface is optionally displayed on a tab of the web browser (e.g., the tab 106). Alternatively, the web browser may include an application affordance 402, and the user interface (e.g., the application window 406) is opened in response to a user action on the application affordance 402. As such, the method 600 could be implemented by the browser application 102 via a tab 106 or an application window 406. Alternatively, in some other implementations not shown in FIGS. 1 and 3, the method 600 is implemented in a mobile application distinct from the browser application 102 or in another client application.

The user interface includes (612) one or more display components of a text entry pane 110 for entering note information, a clipping pane 112 for displaying clipping candidates, a summary pane 108 for listing the one or more content categories, and an action pane 202 for displaying a plurality of currently available actions 204. The computer displays (614) a set of selection snippets (e.g., clipping snippets 114 and 208) on the clipping pane 112. The set of selection snippets are associated with one or more clipping candidates including the candidate web page. The candidate web page could be selected manually or according to the one or more content categories. In some implementations, one or more action buttons are displayed on the action pane 202 for one or more of a Merge and Clip action, a Choose Fragments action, a Clip with Table of Content (TOC) action, a Merge and Clip with TOC, and an Add to Related Notes action.

The computer extracts (616) at least a fragment of the digital content (e.g., the fragment 306 or the selected clipping snippets 208A-208D) into a digital content collection 116 that is associated with the user in a content management application 104. In some implementations, related pages are extracted from the digital content collection 116. Specifically, the related pages are identified in the content collection 116 of the content management application 104 by applying one or more of similarity measurements, natural language processing and artificial intelligence to the digital content and content of the retrieved related pages. Then, the at least a fragment of the digital content is added into a content item 122 associated with the related pages, and the content item is then listed in the content collection 116 of the content management application 104. It is noted that one or more fragments of the digital content or the entire digital content are therefore analyzed, categorized, presented, extracted, and inserted into the digital content collection 116 of the content management application 104.

In some implementations, the method 600 is implemented automatically and without user intervention. For example, the method 600 can also be executed independently of a user opening a web browser tab. Digital content is evaluated autonomously based on the user's recent browsing and clipping history (e.g., information in the browsing history 120). Such evaluation could be done asynchronously, periodically or according to a predetermined schedule.

It should be understood that the particular order in which the operations in FIGS. 5 and 6 have been described are merely exemplary and are not intended to indicate that the described order is the only order in which the operations could be performed. One of ordinary skill in the art would recognize various ways to reorder the operations described herein. Additionally, it should be noted that details of processes described with respect to method 500 (e.g., FIG. 5) are also applicable in an analogous manner to method 600 described above with respect to FIG. 6, and that details of processes described with respect to method 600 (e.g., FIG. 6) are also applicable in an analogous manner to method 00 described above with respect to FIG. 5.

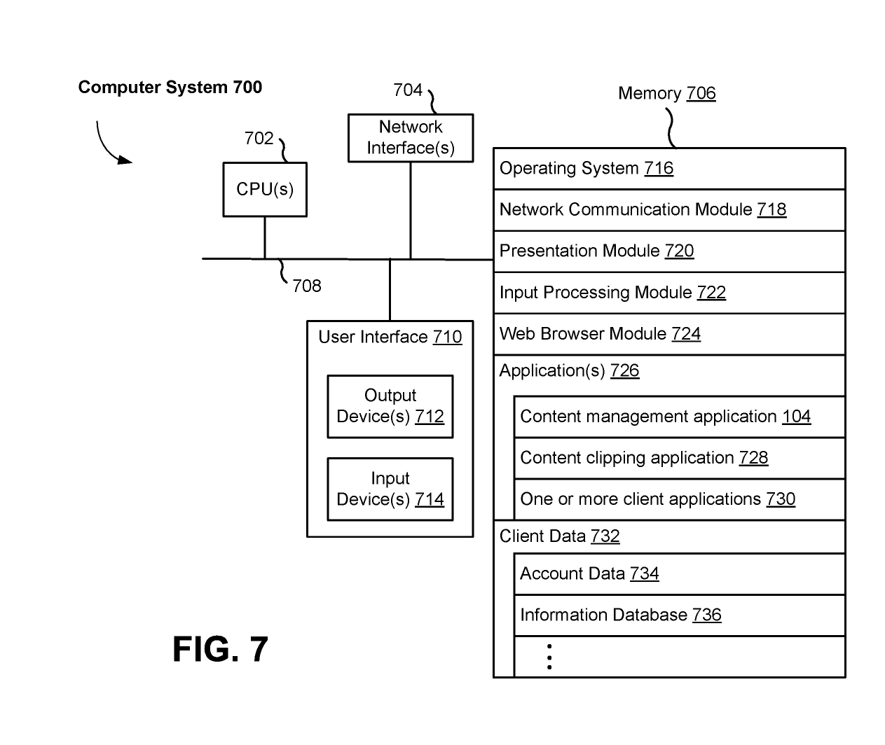

FIG. 7 is a block diagram of a computer system 700 that manages content clipping from a browser application 102 in accordance with some implementations. The computer system 700, typically, includes one or more processing units (CPUs) 702, one or more network interfaces 704, memory 706, and one or more communication buses 708 for interconnecting these components (sometimes called a chipset). The computer system 700 also includes a user interface 710. User interface 710 includes one or more output devices 712 that enable presentation of structured or unstructured information (e.g., the handwritten sales note 102, the audio sales note 104 and the sales form 106). User interface 710 also includes one or more input devices 714, including user interface components that facilitate user input such as a keyboard, a mouse, a voice-command input unit or microphone, a touch screen display, a touch-sensitive input pad, a camera, or other input buttons or controls. Furthermore, in some implementations, the computer system 700 uses a microphone and voice recognition or a camera and gesture recognition to supplement or replace the keyboard. Optionally, the computer system 700 includes one or more cameras, scanners, or photo sensor units for capturing images. Optionally, the computer system 700 includes a microphone for recording an audio clip.

Memory 706 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 706, optionally, includes one or more storage devices remotely located from one or more processing units 702. Memory 706, or alternatively the non-volatile memory within memory 706, includes a non-transitory computer readable storage medium. In some implementations, memory 706, or the non-transitory computer readable storage medium of memory 706, stores the following programs, modules, and data structures, or a subset or superset thereof:
Operating system 716 including procedures for handling various basic system services and for performing hardware dependent tasks;
Network communication module 718 for connecting the computer system 700 to other computer systems (e.g., a server) via one or more network interfaces 704 (wired or wireless);
Presentation module 720 for enabling presentation of information (e.g., a graphical user interface for presenting application(s) 726, widgets, websites and web pages thereof, and/or games, audio and/or video content, text, etc.) at the computer system 700 via one or more output devices 712 (e.g., displays, speakers, etc.) associated with user interface 710;
Input processing module 722 for detecting one or more user inputs or interactions from one of the one or more input devices 714 (e.g., a keyboard) and interpreting the detected input or interaction in conjunction with one or more applications 726;
Web browser module 724 for navigating, requesting (e.g., via HTTP), and displaying websites and web pages thereof in a browser application 102;
One or more applications 726 for execution by the computer system 700, including, but not limited to, a content management application 104, a content clipping application 728 and one or more other client applications 730;
Client data 732 storing data associated with the one or more applications 726, including, but is not limited to:
   Account data 734 storing information related with accounts of the browser application 102 or the content management application 104; and
   Information database 736 for selectively storing a navigation/browsing history 120 of the browser application 102, a content collection 116 of the content management application 104, categories associated with page snippets 114 of the browser application 102, categories associated with content items of the content management application 104, and the like.

In some implementations, the browser application 102 and the content management application 104 are configured to at least partially implement the methods 500 and 600 for clipping the entire web page or one or more fragments of the web page corresponding to the selected page snippets 116 for use in the content management application 104. Specifically, in an example, the browser application 102 provides an application window 406 or a tab 106 for content clipping associated with the content management application 104. Alternatively, in some implementations, a dedicated content clipping application 728 or another client application is configured to clip content for the content management application 104.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 706, optionally, stores a subset of the modules and data structures identified above. Furthermore, memory 706, optionally, stores additional modules and data structures not described above.

A person skilled in the art would recognize that particular embodiments of the computer system 700 may include more or fewer components than those shown. One or more modules may be divided into sub-modules, and/or one or more functions may be provided by different modules than those shown. In some embodiments, an individual one of computer system 700 implements or performs one or more methods described herein with respect to FIGS. 5 and 6. In some embodiments, a plurality of machines (e.g., a local computer and one or more remote servers) together implement or perform one or more methods described with respect to FIGS. 5 and 6. For example, a first computer system (e.g., a server) obtains a browsing history including pages displayed in current open tabs from a second computer system (e.g., a local computer) via one or more wired or wireless communication networks. The first computer system categorizes digital content obtained from the browsing history, generates an application window or tab, and enables display of the application window or tab on the second computer system for its user to select a snippet or a fragment of a web page corresponding to a selected snippet in a clipping operation. The selected snippet or fragment of the web page are inserted as a content item into a content management application 104 executed on the second computer system. More details on content management involving the browser application 102 and the content management application 104 are discussed above with reference to FIGS. 1-6.

Reference is made herein in detail to implementations, examples of which are illustrated in the accompanying drawings. In the detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, mechanical structures, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first answer term could be termed a second answer term, and, similarly, a second answer term could be termed a first answer term, without departing from the scope of the various described implementations. The first answer term and the second answer term are both answer terms, but they are not the same answer terms.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, components, structures and/or groups, but do not preclude the presence or addition of one or more other features, integers, steps, operations, elements, components, structures, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

It is noted that the computer system described herein is exemplary and is not intended to be limiting. For example, any components and modules described herein are exemplary and are not intended to be limiting. For brevity, features or characters described in association with some implementations may not necessarily be repeated or reiterated when describing other implementations. Even though it may not be explicitly described therein, a feature or characteristic described in association with some implementations may be used by other implementations.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

The above description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

What is claimed is:

1. A method for digital content clipping, comprising:
in a computer with a processor and memory including one or programs executable by the processor to perform:
obtaining digital content and an address of a web page opened in a web browser of a user;
evaluating one or more of the digital content and the address to identify the web page as a candidate web page for clipping;
categorizing the candidate web page based one or more content categories, the one or more content categories including one or more of availability and organization of related content items, page sequence in a user browsing history, frequency of access by user, time spent on page, and one or more topic descriptions; and
extracting at least a fragment of the digital content into a digital content collection that is associated with the user in a content management application.

2. The method of claim 1, further comprising:
opening a user interface on a client display corresponding to the web page, the user interface including one or more display components of a text entry pane for entering note information, a clipping pane for displaying clipping candidates, a summary pane for listing the one or more content categories, and an action pane for displaying a plurality of currently available actions; and
displaying a set of selection snippets on the clipping pane, the set of selection snippets being associated with one or more clipping candidates including the candidate web page.

3. The method of claim 2, wherein the user interface is displayed on a tab of the web browser.

4. The method of claim 2, wherein the web browser includes an application affordance, and the user interface is opened in response to a user action on the application affordance.

5. The method of claim 2, further comprising:
displaying one or more action button for one or more of a Merge and Clip action, a Choose Fragments action, a Clip with Table of Content (TOC) action, a Merge and Clip with TOC, and an Add to Related Notes action.

6. The method of claim 1, wherein the evaluating further comprises:
excluding the web page as a candidate for clipping if the address is specified on a stop list or if the digital content of the page does not include useful information or includes information that is excluded from clipping per a policy applicable to the user.

7. The method of claim 1, wherein the method is implemented automatically and without user intervention.

8. The method of claim 1, wherein the digital content and the address of the web page are retrieved from a browsing history of the user in the web browser.

9. The method of claim 1, further comprising:
retrieving related pages from the digital content collection, including identifying the related pages in the content collection of the content management application by applying one or more of similarity measurements, natural language processing and artificial intelligence to the digital content and content of the retrieved related pages.

10. The method of claim 9, further comprising:
adding the fragment of the digital content into a content item associated with the related pages, the content item being listed in the content collection of the content management application.

11. A computer, comprising:
a processor; and
memory including one or programs executable by the processor to perform:
obtaining digital content and an address of a web page opened in a web browser of a user;
evaluating one or more of the digital content and the address to identify the web page as a candidate web page for clipping;
categorizing the candidate web page based one or more content categories, the one or more content categories including one or more of availability and organization of related content items, page sequence in a user browsing history, frequency of access by user, time spent on page, and one or more topic descriptions; and
extracting at least a fragment of the digital content into a digital content collection that is associated with the user in a content management application.

12. The computer of claim 11, wherein the memory further includes one or programs executable by the processor to perform:
opening a user interface on a client display corresponding to the web page, the user interface including one or more display components of a text entry pane for entering note information, a clipping pane for displaying clipping candidates, a summary pane for listing the one or more content categories, and an action pane for displaying a plurality of currently available actions; and
displaying a set of selection snippets on the clipping pane, the set of selection snippets being associated with one or more clipping candidates including the candidate web page.

13. The computer of claim 12, wherein the extracted at least a fragment of the digital content includes the entire digital content.

14. The computer of claim 12, wherein the web browser includes an application affordance, and the user interface is opened in response to a user action on the application affordance.

15. The computer of claim 12, wherein the memory further includes one or programs executable by the processor to perform:
displaying one or more action button for one or more of a Merge and Clip action, a Choose Fragments action, a Clip with Table of Content (TOC) action, a Merge and Clip with TOC, and an Add to Related Notes action.

16. A non-transitory computer readable storage medium storing one or more programs configured for execution by a computer, the one or more programs comprising instructions for:
obtaining digital content and an address of a web page opened in a web browser of a user;
evaluating one or more of the digital content and the address to identify the web page as a candidate web page for clipping;
categorizing the candidate web page based one or more content categories, the one or more content categories including one or more of availability and organization of related content items, page sequence in a user browsing history, frequency of access by user, time spent on page, and one or more topic descriptions; and
extracting at least a fragment of the digital content into a digital content collection that is associated with the user in a content management application.

17. The non-transitory computer readable storage medium of claim 16, wherein the evaluating further comprises:
excluding the web page as a candidate for clipping if the address is specified on a stop list or if the digital content of the page does not include useful information or includes information that is excluded from clipping per a policy applicable to the user.

18. The non-transitory computer readable storage medium of claim 16, wherein the digital content and the address of the web page are retrieved from a browsing history of the user in the web browser.

19. The non-transitory computer readable storage medium of claim 16, the one or more programs further comprising instructions for:
retrieving related pages from the digital content collection, including identifying the related pages in the content collection of the content management application by applying one or more of similarity measurements, natural language processing and artificial intelligence to the digital content and content of the retrieved related pages.

20. The non-transitory computer readable storage medium of claim 19, the one or more programs further comprising instructions for:
adding the fragment of the digital content into a content item associated with the related pages, the content item being listed in the content collection of the content management application.
